(19) United States
(12) Patent Application Publication
(10) Pub. No.: US 2023/0360525 A1
(43) Pub. Date: Nov. 9, 2023

(54) METHOD AND USER TERMINAL FOR OPERATING A MOTORCYCLE IN A GROUP OF MOTORCYCLES

(71) Applicant: Robert Bosch GmbH, Stuttgart (DE)

(72) Inventors: Andre Christian Rossbach, Steinheim (An DerMurr) (DE); Christian Cosyns, Peine (DE); Florian Mayer, Ditzingen (DE)

(21) Appl. No.: 18/311,135

(22) Filed: May 2, 2023

(30) Foreign Application Priority Data
May 4, 2022 (DE) 10 2022 204 372.3

(51) Int. Cl. G08G 1/0968; G08G 1/123; G01C 21/34

(52) U.S. Cl. CPC G08G 1/096838; G08G 1/123; G01C 21/3484

(57) ABSTRACT

A method for operating a motorcycle in a group of motorcycles. A restriction characteristic predefined for the motorcycle is compared to a route characteristic of route sections on a planned route of the group, and an alternative route including the restriction characteristic around at least one route section is planned for the motorcycle if the route characteristic of the route section and the restriction characteristic are incompatible.

### CROSS REFERENCE

The present application claims the benefit under 35 U.S.C. § 119 of German Patent Application No. DE 10 2022 204 372.3 filed on May 4, 2022, which is expressly incorporated herein by reference in its entirety.

### FIELD

The present invention relates to a method for operating a motorcycle in a group of motorcycles, to a corresponding user terminal, and a corresponding computer program product.

### BACKGROUND INFORMATION

When traveling in a group of motorcycles, the group can only travel a route that corresponds to an ability of the weakest rider of the group, or which can be traveled by all motorcycles of the group.

### SUMMARY

The present invention provides a method for operating a motorcycle in a group of motorcycles, a corresponding user terminal, and a corresponding computer program product. Advantageous embodiments, refinements, and improvements of the present invention are disclosed herein.

According to an example embodiment of the present invention, a regional search for an alternative route for at least one motorcycle of a group of motorcycles is carried out if a selected route of the group does not match a route wish of a rider of the motorcycle, does not match a driving ability of the rider, and/or is not suitable for the motorcycle.

The approach according to the present invention makes it possible for different motorcycles and riders of different abilities and/or route wishes to jointly travel a route in a group at least in some sections. Unsuitable sections that do not match these sections are bypassed by the motorcycles. After the unsuitable sections, the group comes together again and jointly continues its travel along the route.

According to an example embodiment of the present invention, a method for operating a motorcycle in a group of motorcycles is provided in which a restriction characteristic predefined for the motorcycle is compared to a route characteristic of route sections along a scheduled route of the group, and an alternative route around a route section featuring a restriction characteristic is planned for the motorcycle if the route characteristic of the route section and the restriction characteristic are incompatible.

Ideas in connection with embodiments of the present invention may be considered to be based, among others, on the ideas and recognitions described in the following text.

A motorcycle may be a driven two-wheeled vehicle. For example, the motorcycle may be a motorbike, a moped or a motor scooter. The motorcycle could be equipped with an electric drive or a combustion engine.

A group of motorcycles may be made up of different motorcycles. A restriction characteristic is able to be predefined for each motorcycle. The restriction characteristic represents characteristics of the motorcycle and/or characteristics of a rider of the motorcycle. The restriction characteristic represents preselected restrictions for the motorcycle and/or preselected restrictions for the rider. The restriction characteristic therefore represents the roads that a certain rider using a certain motorcycle may not drive and/or is unwilling to drive. For example, the restriction characteristic can represent a model type of the motorcycle. The restriction characteristic may represent a motorization of the motorcycle. The restriction characteristic may represent noise emissions of the motorcycle. The restriction characteristic may represent driving characteristics of the motorcycle. For example, the restriction characteristic can represent a minimum cornering radius of the motorcycle and/or a maximum lean angle of the motorcycle. The restriction characteristic may also represent tires of the motorcycle and a ground clearance of the motorcycle. The restriction characteristic may represent a driving ability of the rider. In the same way, the restriction characteristic may represent rider expectations on the route.

A route section may make demands on the motorcycle and/or the rider. A demand is represented by a route characteristic. More specifically, the route characteristic represents the minimum demands on the rider and the motorcycle to allow the rider to drive on the route section with the motorcycle. For example, the route characteristic may represent the poorest road surface of the route section. The route characteristic may represent a minimum curve radius on the route section. The route characteristic can represent a maximum uphill gradient and/or a maximum downhill gradient on the route section. The route characteristic may particularly represent an overall character of the route section, that is, the difficulty of traveling the route section. The route characteristic may represent special obstacles on the route section such as water crossings. The route characteristic may also represent restrictions on the use of the route section. For example, the route characteristic may represent a noise restriction along the route section. In the same way, the route characteristic may represent emission restrictions along the route section.

According to an example embodiment of the present invention, if the route characteristic of at least one route section along the route is incompatible with the restriction characteristic, then an alternative route via at least one alternative route section for which the route characteristic fits the restriction characteristic is planned. The alternative route could be longer, of equal length, or shorter than the omitted route sections.

According to an example embodiment of the present invention, it is possible to predefine the restriction characteristic using a rider class of the rider that represents the driving ability of a rider of the motorcycle. A rider class, for example, may be a beginner, experienced or skilled class. The rider is able to assign his/or her own rider class. The rider class may improve through experience, that is, over time and the traveled distances. The rider class may represent a preselected maximally desired degree of difficulty.

The restriction characteristic is able to be predefined using a motorcycle class of the motorcycle which represents technical restrictions of the motorcycle. For example, a motorcycle class may be a chopper, a touring bike, a superbike or an Enduro motorcycle. The motorcycle class, for example, may present expected noise emissions of the motorcycle. In the same way, the motorcycle class can represent a maximum lean angle of the motorcycle typical of the model type.

According to an example embodiment of the present invention, the alternative route is able to be planned with a driving time that essentially corresponds to a driving time on the route between a branching-off point of the alternative route from the route and a merging point of the alternative route with the route. The alternative route may leave the route at a branching-off point and rejoin the route again at a merging point. The omitted route section of the route and also the alternative route sections of the alternative route lie between the branching-off point and the merging point. The travel on the alternative route may last approximately as long as the route between the branching-off point and the merging point. Roughly identical driving times make it possible to avoid wait times for the rest of the group.

In addition, according to an example embodiment of the present invention, a route featuring the restriction characteristic and leading to the starting point may be planned for the motorcycle. A route to a starting point may lead from a current location of the motorcycle to the starting point of the route. The route to the starting point can lead across route sections whose route characteristics match the restriction characteristic of the motorcycle.

A departure time for beginning the route to the starting point of the route is able to be determined using a scheduled starting time of the group for the route. The departure time can be selected in such a way that the motorcycle reaches the starting point ahead of the starting time. This avoids wait times for the rest of the group.

Alternatively, according to an example embodiment of the present invention, the starting time of the group on the route can be determined using a desired departure time for the start of the route to the starting point. In particular, the starting time is able to be defined by the motorcycle having the longest route to reach the starting point of the route. All other departure times of the group can be determined so that they match the starting time. All participants of the group are thereby able to arrive at the starting point at roughly the same time. The desired departure time may be predefined by a time restriction, for example.

The departure time for beginning the route to the starting point of the route is able to be planned based on a desired length of the route to the starting point. A desired length may extend the route to the starting point of the route. An advance tour may be traveled in this way. The length of the route to the starting point route can be selected in the form of a route or time.

The route to the starting point of the route is able to be planned based on an arrival time within a tolerance range before a scheduled starting time of the group. A tolerance range makes it possible to avoid a late start of the group for the route. A tolerance range may be referred to as a time buffer.

The method of the present invention is preferably computer-implemented and may be realized in software or hardware or in a mixed form of software and hardware, for instance in a control unit.

The present invention furthermore provides a user terminal, which is designed to execute, actuate, or implement the steps of a variant of the method according to the present invention in corresponding devices. The user terminal, for example, may be a mobile device of a rider of a motorcycle. In the same way, the user terminal may be a navigation system of the motorcycle.

The user terminal may be an electric device having at least one computing device for processing signals or data, at least one memory unit for storing signals or data, and at least one interface and/or a communication interface for reading in or outputting data, which are embedded in a communication protocol. For example, the computing device may be a signal processor, a so-called system ASIC, or a microcontroller for processing sensor signals and outputting data signals as a function of the sensor signals. For example, the memory unit may be a flash memory, an EPROM, or a magnetic memory unit. The interface is able to be developed as a sensor interface for reading in the sensor signals from a sensor, and/or as an actuator interface for outputting the data signals and/or control signals to an actuator. The communication interface may be developed to read in or output the data in a wireless and/or a wire-conducted manner. The interfaces may also be software modules, which are provided on a microcontroller in addition to other software modules, for example.

Advantageous is also a computer program product or a computer program having program code which may be stored on a machine-readable carrier or memory medium such as a semiconductor memory, a hard disk memory or an optical memory and is used to execute, implement, and/or actuate the steps of the method of one of the above-described embodiments of the present invention, in particular when the program product or program is executed on a computer or a device.

It is pointed out that a few of the possible features and advantages of the present invention have been described here with reference to different embodiments. One skilled in the art will understand that the features of the control unit and the method are able to be suitably combined, adapted or exchanged to arrive at further embodiments of the present invention.

### BRIEF DESCRIPTION OF THE DRAWINGS

Below, embodiments of the present invention are described with reference to the figures, but neither the figures nor the description should be interpreted as restricting the present invention.

FIG. 1 shows a representation of alternative routes to a route of a group of motorcycles, according to an example embodiment of the present invention.

FIG. 2 shows a representation of routes to a starting point of a route of a group of motorcycles, according to an example embodiment of the present invention.

The figures are merely schematic and not true to scale. Identical reference numerals denote identical or similarly acting features.

### DETAILED DESCRIPTION OF EXAMPLE EMBODIMENTS

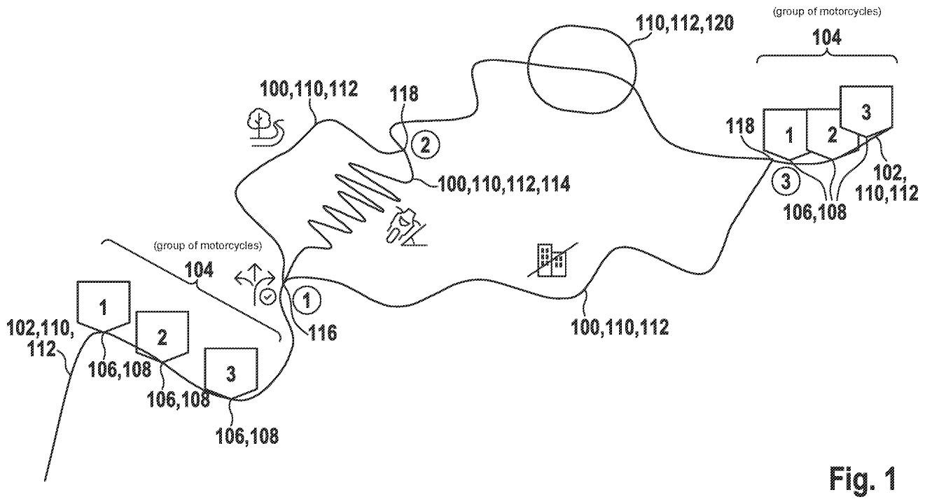

FIG. 1 shows a representation of alternative routes 100 to a route 102 of a group 104 of motorcycles 106. An individual restriction characteristic 108 has been predefined for each motorcycle 106. Restriction characteristic 108 of motorcycles 106 represents different technical preconditions of motorcycles 106. In the same way, restriction characteristics 108 represent different driver-related preconditions of riders of motorcycles 106. These preconditions define individual restrictions in the route selection for each motorcycle 106. These restrictions are stored for each motorcycle 106 in individual restriction characteristic 108.

For example, a maximally possible lean angle of motorcycle 106 or a minimum cornering radius of motorcycle 106 is able to be stored in restriction characteristic 108. In the same way, a noise emission of motorcycle 106 can be stored in restriction characteristic 108. A driving ability of the rider may furthermore be stored in restriction characteristic 108. The route characteristic preferred by the rider may also be stored in restriction characteristic 108.

Route 102 leads across route sections 110. A route characteristic 112 is assigned to each route section 110. Route characteristics 112 represent characteristics of route sections 110.

For example, a minimum curve radius of route section 110 may be stored in route characteristic 112. In the same way, a noise restriction on route section 110 can be stored in route characteristic 112. A difficulty assessment of route section 110 may also be stored in route characteristic 112. A curviness of route 110 can be stored in road characteristic 112. A road surface and a condition of the road surface of route section 110 can be stored in route characteristic 112. Special obstacles such as a water crossing may also be stored in route characteristic 112.

In the approach introduced here, route characteristics 112 of route sections 110 of route 102 are compared to restriction characteristics 108 of motorcycle 106 for each motorcycle 106. If route characteristics 112 do not fit restriction characteristic 108, an alternative route 100 around these route sections 110 is planned. Alternative route 100 is planned along route sections 110 whose route characteristics 112 fit restriction characteristic 108 of a respective motorcycle 106.

In one exemplary embodiment, route 102 extends via a serpentine route 114. Restriction characteristics 108 of at least one of motorcycles 106 is incompatible with route characteristic 112 of serpentine route 114. For example, serpentine route 114 is evaluated as too difficult for the rider. In the same way, motorcycle 106 may have too large a minimum cornering radius or too low a maximum lean angle. In the same way, the rider may have noted in restriction characteristic 108 that he does not like serpentines and would prefer to travel along avenues. For that reason, an alternative route 100 which avoids serpentine route 114 will be planned for motorcycle 106. Motorcycle 106 leaves route 102 at a branching-off point 116. Via alternative route 100, motorcycle 106 returns to route 102 again at a merging point 118 behind serpentine route 114.

In one exemplary embodiment, route 102 leads through a town 120. Restriction characteristic 108 of at least one of motorcycles 106 is not compatible with route characteristic 112 of route section 110 through town 120. For example, motorcycle 106 is too noisy for town 120 and/or may not enter the environmental zone. In the same way, the rider may have noted in restriction characteristic 108 that he is not fond of city driving and would prefer travel along cow paddocks. An alternative route 100 which circumvents town 120 is therefore planned for motorcycle 106. Motorcycle 106 leaves route 102 at a branching-off point 116.

Via alternative route 100, motorcycle rejoins route 102 behind city 116 at a merging point 118.

In one exemplary embodiment, alternative route 100 is planned in such a way that a driving time via alternative route 100 essentially corresponds to the driving time via route 102 between branching-off point 116 and merging point 118. To this end, a length of alternative route 100 is selected so that a matching driving time results at a driving style that corresponds to restriction characteristic 108. More particularly, alternative route 100 is selected to be slightly shorter so that motorcycle 106 reaches merging point 118 ahead of group 104 and group 104 does not have to wait.

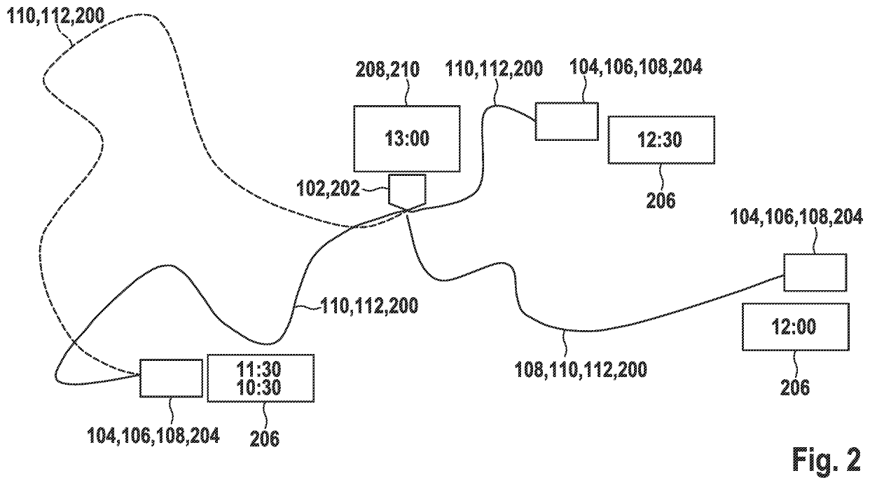

FIG. 2 shows a representation of routes 200 leading to a starting point 202 of a route 102 of a group 104 of motorcycles 106. Starting point 202 corresponds to a meeting point of at least two group members of group 104. Other group members may join later in the course of route 102. For these group members, too, starting-point routes 200 to intermediate points of route 102 can be planned. As an alternative, all group members may meet at starting point 202 and start on route 102 from there.

Route 200 to a starting point is planned from a position 204 of motorcycle 106. Route 200 to a starting point is planned by way of route sections 110 whose route characteristics 112 fit restriction characteristic 108 of motorcycle 106.

In one exemplary embodiment, a departure time 206 at position 204 is planned in such a way that motorcycle 106 reaches starting point 202 shortly before a starting time 208 of group 104 using a driving style that corresponds to restriction characteristic 108.

In one exemplary embodiment, starting time 208 is specified by an arrival time 210 of one of motorcycles 106 at starting point 202. Arrival time 210 results from the fixed departure time 206, a length route 200 to the starting point, and the rider's driving style stored in restriction characteristic 108. Starting time 208 thus affects departure times 206 of all group members. In particular, starting time 208 is specified as a function of longest route 200 to the starting point. Departure times 206 for shorter routes 200 to the starting point are then calculated accordingly.

In one exemplary embodiment, the length of route 200 to the starting point is specified, and a departure time 206 that matches starting time 208 is calculated accordingly. A pre-tour may thus precede the common tour.

In one exemplary embodiment, the length of route 200 to the departure point is calculated in such a way that route 200 to the departure point begins at a desired departure time 206 and starting point 202 is reached shortly before starting time 208.

In the following text, possible embodiments of the present invention are summarized again or described using a slightly different choice of words.

An optimized route guidance for group travel for a personalized route guidance and navigation according to a route classification is introduced.

Motorcyclists have the ability to communicate with the vehicle or with one another while driving. Motorcyclists can be guided along particularly curvy routes.

In the approach introduced here, a rider, on his own or in a group, is able to select a specific route in accordance with his driving ability and/or his vehicle type. A novice rider, for example, may select a less challenging route. In the same way, a rider of a sportbike may select a route without gravel or water crossings.

In connection with a group event or a common group in which different riders and vehicles are able to take part, this function serves the purpose of giving the rider in a common group the option of switching to a different route at a certain point in an effort to circumvent a specific part of the route, but also gives the rider the option of returning to the common route again at a specific point, with the result that no participant will be forced to wait for another participant. Additional information about the vehicle type and/or the rider ability is/are utilized for this purpose. The information is able to be input manually or be acquired automatically via a data interface.

After all participants have agreed on a tour, the participants can adapt the route to their personal needs.

If a rider wants to circumvent certain route sections because of his driving ability, then the rider can make an appropriate manual adjustment during the planning phase, or he may receive an automatic suggestion during the tour. This could be similar to the route classification principle, as already available in winter sports. For example, sections that are easy to travel may be marked in green, and sections that are challenging may be marked in black, for example.

In FIG. 1, rider 1 is a novice rider and preferably travels easy routes. For that reason, he leaves the common route at point 1 and returns to it again at point 3. In this case, the alternative route is calculated in such a way that the rider optimally reaches point 3 at the same time as riders 2 and 3.

Rider 2 is a seasoned rider and prefers travel on routes that, at most, are declared to have a medium degree of difficulty. Rider 2 leaves common route at point 1 and returns to it again at point 2. In this case, the alternative route is calculated in such a way that he optimally reaches point 2 at the same time as rider 3. All riders then jointly arrive at point 3.

Rider 3 is a skilled rider and preferably travels on challenging routes of all degrees of difficulty. He leaves the common route at point 1 and returns to it again at point 2, optimally at the same time as rider 2. All riders then jointly arrive at point 3.

If a rider wants to circumvent certain route sections on account of his vehicle type, the rider can make manual adaptations during the planning phase, or it may be automatically suggested to him during the ride. This may follow the route classification principle in which other vehicles automatically label a route, and/or the information, e.g., dirt roads, is stored in the map material. Sections may be declared/marked according to the signage, for example.

In FIG. 1, rider 1 has a vehicle which, due to its driving noise, for example, is permitted only on routes without a noise restriction. He departs from the common route at point 1 and returns to it again at point 3. The alternative route is calculated in such a way that he optimally arrives point 3 at the same time as riders 2 and 3.

Rider 2 has a vehicle featuring a limited lean angle, such as a chopper model. As a result, he would have problems on the difficult route. For that reason, he leaves the common route at point 1 for a route of medium difficulty and returns to it again at point 2. The alternative route is calculated in such a way that he optimally arrives at point 2 at the same time as rider 3. All riders then jointly arrive at point 3.

Rider 3 has a touring vehicle which provides good cornering for tight curves such as the difficult route. He leaves the common route at point 1 and returns to it again at point 2, optimally at the same time as rider 2. All riders then jointly arrive at point 3.

The option for the riders of a group may be limited either to one of the two variants, or each rider may select his own method regardless of the choice of the other participants. In all cases, the goal is the common meeting point in terms of location and time.

The system is predominantly configured for a communication between motorcyclists of a group via their smartphones and, in particular, for navigation functions. However, the system may also be used for vintage cars, bicycles, or similar vehicles.

In addition, an optimized route guidance for group travel for a simplified determination and navigation to the common meeting point is introduced.

Here, a communication of motorcyclists with one another and for organizing different starting points with a common arrival at a destination is introduced.

For example, the destination may be a common starting point for an excursion. An appropriate starting time for his defined starting location is individually determined for each rider so that all riders from different starting points arrive at the destination at the same time.

The information about the starting point is able to be determined by the GPS position of the smartphone, for example. As an alternative, the starting point can also be input manually if the rider happens to be at a location that differs from his later starting point during the planning phase.

To ensure that all participants arrive at a defined meeting point at the same time, the riders are notified and informed of their respective starting time. In the process, the scheduled common arrival time at the meeting point is able to be specified. As an alternative, the earliest possible starting time of the participants can be specified and the arrival time for the meeting point be predefined in this way.

If the rider wants to arrive at the common meeting point via the fastest route, then the matching route is determined in manner that is optimized for a route, and the corresponding starting time is calculated. The starting point/location and the driving time to the destination are thus decisive for determining the starting time (chronological time).

If the rider wishes to start even earlier and would like to use the time for a preceding tour, then the desired starting time may be queried and a matching route be determined to ensure the arrival time at the common meeting point.

Finally, it is pointed out that terms such as ‘having’, ‘including’, etc. do not exclude other elements or steps, and terms such as ‘a’, ‘an’ do not exclude a multiplicity. Reference numerals should not be considered a limitation.

What is claimed is:

1. A method for operating a motorcycle in a group of motorcycles, the method comprising the following steps:
comparing a restriction characteristic predefined for the motorcycle to a route characteristic of route sections along a scheduled route of the group; and
planning an alternative route including the restriction characteristic around at least one route section for the motorcycle based on the route characteristic of the route section and the restriction characteristic being incompatible with one another.

2. The method as recited in claim 1, wherein the restriction characteristic is predefined using a rider class of the rider that represents a driving skill of a rider of the motorcycle.

3. The method as recited in claim 1, wherein the restriction characteristic is predefined using a motorcycle class of the motorcycle which represents technical restrictions of the motorcycle.

4. The method as recited in claim 1, wherein the alternative route is planned with a driving time that corresponds to a driving time on the route between a branching-off point of the alternative route from the route and a merging point of the alternative route with the route.

5. The method as recited in claim 1, wherein a route to the starting point of the scheduled route and including the restriction characteristic is furthermore planned for the motorcycle to a starting point of the scheduled route.

6. The method as recited in claim 5, wherein a departure time for beginning the route to the starting point of the scheduled route is determined using a scheduled starting time of the group for the scheduled route.

7. The method as recited in claim 5, wherein a starting time of the group on the scheduled route is determined using a desired departure time for beginning the route to the starting point.

8. The method as recited in claim 5, wherein a departure time for beginning the route to the starting point is planned based on a desired length of the route to the starting point.

9. The method as recited in claim 5, wherein the route to the starting point of the route is planned with an arrival time within a tolerance range before a scheduled starting time of the group.

10. A user terminal for operating a motorcycle, comprising:
a control device configured to operate a motorcycle in a group of motorcycles, the control device configured to:
compare a restriction characteristic predefined for the motorcycle to a route characteristic of route sections along a scheduled route of the group; and
plan an alternative route including the restriction characteristic around at least one route section for the motorcycle based on the route characteristic of the route section and the restriction characteristic being incompatible with one another.

11. A machine-readable memory medium on which is stored a computer program for operating a motorcycle in a group of motorcycles, the computer program, when executed by a processor, causing the processor to perform the following steps:
comparing a restriction characteristic predefined for the motorcycle to a route characteristic of route sections along a scheduled route of the group; and
planning an alternative route including the restriction characteristic around at least one route section for the motorcycle based on the route characteristic of the route section and the restriction characteristic being incompatible with one another.
